(19) United States
(12) Patent Application Publication
(10) Pub. No.: US 2018/0203683 A1
(43) Pub. Date: Jul. 19, 2018

(54) APPARATUS AND METHOD FOR SOFTWARE UPDATE OF VEHICLE

(71) Applicants: Hyundai Motor Company, Seoul (KR); Kia Motors Corporation, Seoul (KR)

(72) Inventor: Namjoon Kim, Seoul (KR)

(21) Appl. No.: 15/611,688

(22) Filed: Jun. 1, 2017

(30) Foreign Application Priority Data
Jan. 16, 2017 (KR) 10-2017-0006936

(51) Int. Cl. G06F 9/445; G06F 1/28; B60R 16/033

(52) U.S. Cl. CPC G06F 8/65; B60R 16/033; G06F 1/28

(57) ABSTRACT

A method for performing a software update of an electronic vehicle part includes: calculating an expected amount of current consumption for a software update of a plurality of electronic parts equipped in a vehicle; detecting a remaining capacity of a battery of the vehicle; and performing the software update of the plurality of electronic parts when the remaining capacity of the battery is greater than the expected amount of current consumption. The plurality of electronic parts are powered-on one at a time to perform the software update.

### CROSS-REFERENCE TO RELATED APPLICATION

This application claims the benefit of priority to Korean Patent Application No. 10-2017-0006936, filed on Jan. 16, 2017 in the Korean Intellectual Property Office, the disclosure of which is incorporated herein by reference as if fully set forth herein.

### BACKGROUND

### 1. Technical Field

Embodiments of the present disclosure relate generally to vehicular technologies, and more particularly, to an apparatus and method for performing a software update of electronic vehicle parts.

### 2. Description of the Related Art

Many recently developed vehicles include a multimedia device combining an audio device, a video device, and a navigation device into a single system. Other modern electronic vehicle parts include a body control module (BCM) for automatically controlling the positions of a memory seat, a rear or side mirror, steering and suspension units, a chassis control unit associated with control of a brake unit, a power train control unit (TCU) for controlling a transmission, and an engine control unit (ECU) for controlling an engine, among many others.

Each of these vehicle parts is driven by software (or firmware), and the software may be updated to a current version to improve performance of the vehicle. However, software updates may take a long time or be impossible to perform while driving. Thus, many users often delay necessary software updates.

In order to prevent users from delaying software updates, scheduled updates (e.g., at night) may be provided. However, the charge of the vehicle battery must be sufficient at the time of the scheduled update in order for the update to be successful.

### SUMMARY

It is an aspect of the present disclosure to provide an apparatus and method for performing a software update of electronic vehicle parts, capable of executing a software update by considering the remaining capacity of a battery of a vehicle.

Additional aspects of the disclosure will be set forth in the description which follows and, in part, will be apparent from the description, or may be learned by practice of the disclosure.

In accordance with embodiments of the present disclosure, a method for performing a software update of an electronic vehicle part includes: calculating an expected amount of current consumption for a software update of a plurality of electronic parts equipped in a vehicle; detecting a remaining capacity of a battery of the vehicle; and performing the software update of the plurality of electronic parts when the remaining capacity of the battery is greater than the expected amount of current consumption. The plurality of electronic parts are powered-on one at a time to perform the software update.

The performing of the software update may include: powering on one of the plurality of electronic parts; performing the software update on the one electronic part which is powered-on; and powering off the one electronic part when the software update is complete.

The remaining electronic parts may be powered off while the software update of the one electronic part is in progress.

The calculating of the expected amount of current consumption may include: measuring and storing an amount of current required for the software update of the plurality of electronic parts before the performing of the software update; and calculating the expected amount of current consumption based on the stored amount of current.

The detecting of the remaining capacity of the battery may include: detecting the remaining capacity of the battery based on a state of charge (SOC) value and a voltage value of the battery.

The method may further include: detecting a time reserved for the software update; and waking up a head unit involved in the software update of the plurality of electronic parts when the time reserved for the software update is reached.

Furthermore, in accordance with embodiments of the present disclosure, an apparatus for performing a software update of an electronic vehicle part includes: a storage storing an expected amount of current consumption for a software update of a plurality of electronic parts equipped in a vehicle; a detector detecting a remaining capacity of a battery of the vehicle; and a controller calculating the expected amount of current consumption for the software update of the plurality of electronic parts and performing the software update of the plurality of electronic parts when the remaining capacity of the battery is greater than the expected amount of current consumption. The plurality of electronic parts are powered-on one at a time to perform the software update.

The controller may power on one of the plurality of electronic parts, perform the software update on the one electronic part which is powered-on, and power off the one electronic part when the software update is complete.

The controller may power off the remaining electronic parts while the software update of the one electronic part is in progress.

The controller may measure and store an amount of current required for the software update of the plurality of electronic parts before the performing of the software update, and calculate the expected amount of current consumption based on the stored amount of current.

The controller may detect the remaining capacity of the battery based on a state of charge (SOC) value and a voltage value of the battery.

The controller may detect a time reserved for the software update, and wake up a head unit involved in the software update of the plurality of electronic parts when the time reserved for the software update is reached.

Furthermore, in accordance with embodiments of the present disclosure, a method for performing a software update of an electronic vehicle part includes: detecting a time reserved for a software update of a plurality of electronic parts equipped in a vehicle; and performing the software update of the plurality of electronic parts when the time reserved for the software update is reached. The plurality of electronic parts are powered-on one at a time to perform the software update.

The performing of the software update may include: powering on one of the plurality of electronic parts; performing the software update on the one electronic part which is powered-on; and powering off the one electronic part when the software update is complete.

The remaining parts may be powered off while the software update of the one electronic part is in progress.

The method may further include: measuring and storing an amount of current required for the software update of the plurality of electronic parts before the performing of the software update; and calculating an expected amount of current consumption based on the stored amount of current.

The method may further include: detecting the remaining capacity of the battery based on a state of charge (SOC) value and a voltage value of the battery.

Furthermore, in accordance with embodiments of the present disclosure, a method for performing a software update of an electronic vehicle part includes: detecting a time reserved for a software update of a plurality of electronic parts equipped in a vehicle; and performing the software update of the plurality of a plurality of electronic parts equipped in a vehicle parts when the time reserved for the software update is reached. The plurality of electronic parts are powered-on one at a time to perform the software update. The performing of the software update includes: powering on one of the plurality of electronic parts; performing the software update on the one electronic part which is powered-on; and powering off the one electronic part when the software update is complete.

Furthermore, in accordance with embodiments of the present disclosure, a apparatus for performing a software update of an electronic vehicle part includes: a storage unit storing an expected amount of current consumption for a software update of a plurality of electronic parts equipped in a vehicle; a detector detecting a remaining capacity of a battery of the vehicle; and a controller calculating the expected amount of current consumption for the software update of the plurality of electronic parts and performing the software update of the plurality of electronic parts when the remaining capacity of the battery is greater than the expected amount of current consumption. The plurality of electronic parts are powered-on one at a time to perform software update. The software update for each part includes: powering on one of the plurality of electronic parts; performing the software update on the one electronic part which is powered-on; and powering off the one electronic part when the software update is complete.

Accordingly, a software update of an electronic vehicle part can be executed at a scheduled time, but only when the remaining capacity of the vehicle's battery is sufficient. This allows for efficient software updates considering the remaining charge amount of the vehicle battery.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating the exterior of a vehicle according to embodiments of the present disclosure;

FIG. 2 is a diagram illustrating an interior of a vehicle according to embodiments of the present disclosure;

FIG. 3 is a block diagram illustrating a configuration of an apparatus for a software update of a vehicle according to embodiments of the present disclosure;

FIG. 4 is a diagram illustrating a concept of a software update of the vehicle according to embodiments of the present disclosure;

FIG. 5 is a diagram illustrating a method of software update for the vehicle according to embodiments of the present disclosure; and

FIG. 6 is a diagram illustrating an update file for vehicle according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

In the description of the present disclosure, drawings and embodiments shown in the drawings are examples of the disclosed disclosure, and there can be various modifications that can replace the embodiments and the drawings of the present disclosure. The same reference numerals or the same symbols used in the drawings of the present disclosure indicate elements that perform substantially the same function.

In addition, the terms used in the present disclosure are intended to illustrate the embodiments of the present disclosure and are not intended to limit or limit the present disclosure. The singular forms “a”, “an” and “the” include plural referents unless the context clearly dictates otherwise. In the present disclosure, terms such as “include,” “include,” or “have” are intended to specify that there are features, numbers, steps, acts, components. Also, it does not preclude the presence or addition of one or more other features, numbers, steps, operations, components, components, or combinations thereof.

It is also to be understood that terms including ordinals such as “first”, “second”, etc. used herein may be used to describe various elements, but the elements are not limited to these terms. It is used only for the purpose of distinguishing one component from another. For example, without departing from the scope of the present disclosure, the first component may be referred to as a second component, and similarly, the second component may also be referred to as a first component. The term “and/or” includes any combination of a plurality of related listed items or any of a plurality of related listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Reference will now be made in detail to embodiments of the present disclosure, examples of which are illustrated in the accompanying drawings, wherein like reference numerals refer to like elements throughout.

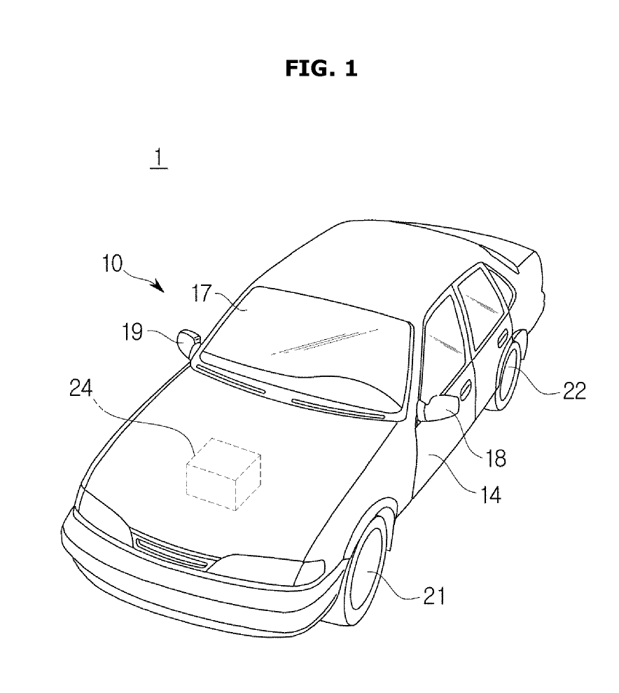

FIG. 1 is a diagram illustrating the exterior of a vehicle according to embodiments of the present disclosure.

As shown in FIG. 1, a vehicle 1 according to embodiments of the present disclosure includes a main body 10 forming the outer appearance of the vehicle 1, wheels 21 and 22 for moving the vehicle 1, a driving device 24 for rotating the wheels 21 and 22, a door 14 for shielding the interior of the vehicle 1 from the outside, a front glass 17 (i.e., windshield) for providing a driver with a forward view of the vehicle 1, side mirrors 18 and 19 for providing a driver with a rearward view of the vehicle 1.

The wheels 21 and 22 include a front wheel 21 provided at the front of the vehicle 1 and a rear wheel 22 provided at the rear of the vehicle 1, and the driving device 24 provides a rotational force to the front wheel 21 or the rear wheel 22 to move the main body 10 forward or backward. The driving device 24 may include an engine that generates a rotating force by combustion of fossil fuel or a motor that generates power by receiving electric power from a capacitor (not shown).

The door 14 is rotatably provided on the left and right sides of the main body 10 so that the driver may ride inside the vehicle 1 at the time of opening of the door 14 and shield the inside of the vehicle 1 from the outside at the time of closing of the door 14. The front glass 17 is provided on the front upper side of the main body 10 so that a driver inside the vehicle 1 may obtain a forward view of the vehicle 1. The front glass 17 is also referred to as a windshield glass. The side mirrors 18 and 19 include a left side mirror 18 provided on the left side of the main body 10 and a right side mirror 19 provided on the right side of the main body 10 so that a driver inside the vehicle 1 may obtain a side view and a rearward view of the main body 10.

The vehicle 1 may further include a sensing device, such as a proximity sensor configured to sense an obstacle behind the vehicle or other vehicles and a rain sensor configured to sense rainfall and the amount of rainfall. For example, the proximity sensor emits a sensing signal toward a side surface or a rear surface of the vehicle 1 and receives a reflection signal reflected from an obstacle, such as other vehicles. Also, the proximity sensor senses the existence of an obstacle behind the vehicle 1 on the basis of a waveform of the received reflection signal, and detects the position of the obstacle. The proximity sensor operates in a way to emit an ultrasonic wave and detect the distance to an obstacle by using the ultrasonic wave reflected from the obstacle.

The vehicle 1 according to embodiments of the present disclosure may be, for example, an electric vehicle (EV), a hybrid electric vehicle (HEV), a plug-in hybrid electric vehicle (PHEV), or a fuel cell electric vehicle (FCEV).

It should be understood that the exterior of the vehicle 1 illustrated in FIG. 1 and described above is provided merely for demonstration purposes, and does not limit the scope of the present disclosure. Thus, the exterior of the vehicle 1 may be modified in any suitable manner consistent with the scope of the present claims.

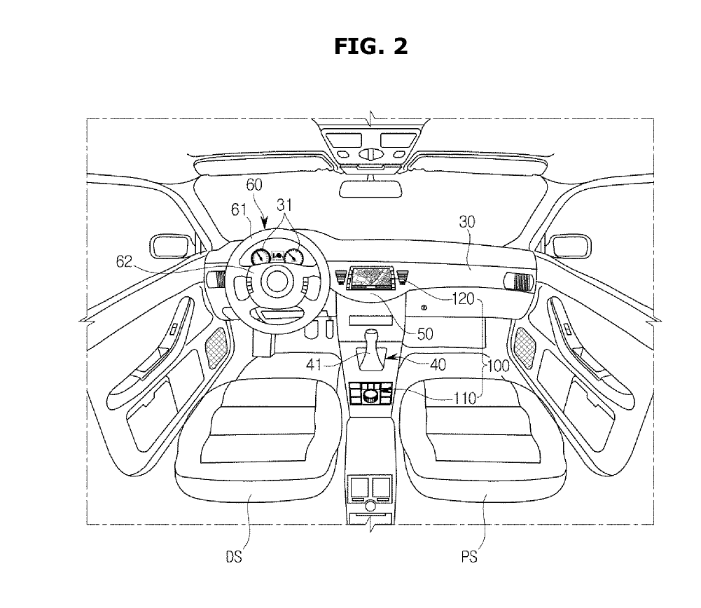

FIG. 2 is a diagram illustrating an interior of a vehicle according to embodiments of the present disclosure.

As shown in FIG. 2, seats DS and PS on which occupants sit, a dashboard 30 on which various instruments for controlling the operation of the vehicle 1 and displaying the driving information of the vehicle 1 are provided, and a steering wheel 60 for operating the direction of the vehicle 1 may be provided in the vehicle 1.

The seats DS and PS may include a driver's seat DS on which a driver sits, a passenger seat PS on which a passenger sits, and a rear seat (not shown) located in the rear of the vehicle 1. The dashboard 30 is provided with an instrumental panel 31 for indicating information related to driving, such as a speedometer, a fuel meter, an automatic shift selector lever indicator, a tachometer and a rangefinder, a gear box 40, and a center fascia 50.

The gear box 40 is provided with a shift lever 41 for shifting gears. In addition, as shown in FIG. 2, an input unit 110 is provided for a user to input a user command for controlling various functions of an Audio-Video-Navigation (AVN) 100 or the vehicle 1.

The center fascia 50 may be provided with an air conditioner, a clock, the AVN 100, and the like. The air conditioner controls the temperature, humidity, air cleanliness, and air flow inside the vehicle 1 to keep the inside of the vehicle 1 comfortable. The air conditioner may include at least one air vent that is installed in the center fascia 50 and discharges air through the at least one air vent. The center fascia 50 may be provided with a button or a dial for controlling the air conditioner or the like. The user such as a driver may control the air conditioner of the vehicle 1 by operating buttons or dials disposed on the center fascia 50.

The AVN 100 is a device that is implemented as a single system by integrating audio and video apparatuses and navigation apparatuses and the like in the vehicle 1. The AVN 100 provides a radio service for broadcasting a radio program based on a terrestrial radio signal, an audio service for replaying a Compact Disk (CD), a video service for replaying an optical disc (e.g., Compact Disk (CD) or Digital Versatile Disk (DVD)), a navigation service for guiding the user along a route to a destination, a telephone service for controlling a reception of calls of a communication terminal connected to the vehicle 1. In addition, the AVN 100 may also provide a voice recognition service that receives a voice other than a user's operation and provides the above-described radio service, audio service, video service, navigation service, and telephone service.

The AVN 100 may be installed on the dashboard 30 or may be embedded inside the center fascia 50. In this case, only a touch screen unit 120 for displaying a touch screen of the AVN 100 may be exposed to the outside. The user may be provided with a radio service, an audio service, a video service, and a navigation service through the AVN 100. The AVN 100 may be referred to as a navigation system or a display device, and may be referred to various other terms used by those skilled in the art. The AVN 100 may be provided with a Universal Serial Bus (USB) port so as to be connected to a communication terminal such as a smart phone, a portable multimedia player (PMP), an MP3 (MPEG Audio Layer-3) player, a Personal Digital Assistants (PDA) to play back digital files for audio and video contents.

The steering wheel 60 is a device for adjusting a driving direction of the vehicle 1. The steering wheel 60 includes a rim 61 and a spoke 62. The rim 61 is gripped by the driver. The spoke 62 is connected to a steering device of the vehicle 1 and connects the rim 61 to a hub of a rotary shaft for steering. For example, the spoke 62 may be provided with an operating device for controlling various devices in the vehicle 1, for example, the AVN 100 and the like.

The AVN 100 may selectively display at least one of a radio screen, an audio screen, a video screen, a navigation screen, and a telephone screen through the touch screen unit 120. For example, the AVN 100 may display various control screens related to the control of the air conditioner through the touch screen unit 120 in conjunction with the air conditioner described above. The AVN 100 may control the air conditioning environment in the vehicle 1 by controlling the operation state of the air conditioner. In addition, the AVN 100 may display a map indicating a path to a destination to the driver through the touch screen unit 120.

The touch screen unit 120 may be implemented as a liquid crystal display (LCD) panel, a light emitting diode (LED) panel, or an organic light emitting diode (OLED). The touch screen unit 120 may perform a screen display function and an instruction or command input function. The touch screen unit 120 displays a screen including a predetermined image according to an operating system (OS) for driving and controlling the AVN 100 and application software running on the AVN 100, or receives an instruction or a command from the user. The touch screen unit 120 may display a basic screen according to application software being executed. The basic screen represents a screen displayed by the touch screen unit 120 when the touch operation is not performed. The touch screen unit 120 may display a touch operation screen according to the situation. The touch operation screen represents a screen capable of receiving a touch operation from the user. An input method of the touch screen unit 120 includes a resistive type touch screen method for sensing the user's touch operation, a capacitive type touch screen method for sensing the user's touch operation by using a capacitive coupling effect, an optical type touch screen method using an infrared ray, or an ultrasonic type touch screen method using ultrasonic waves. In addition, various input methods of touch screen may be used, and the present disclosure is not limited thereto.

The touch screen unit 120 is a device that allows a user to interact with the AVN 100 provided in the vehicle 1. The touch screen unit 120 receives a user command through a touch interaction or the like, and the user command may input by selecting a text or menu displayed on the touch screen unit 120.

It should be understood that the interior of the vehicle 1 illustrated in FIG. 2 and described above is provided merely for demonstration purposes, and does not limit the scope of the present disclosure. Thus, the interior of the vehicle 1 may be modified in any suitable manner consistent with the scope of the present claims.

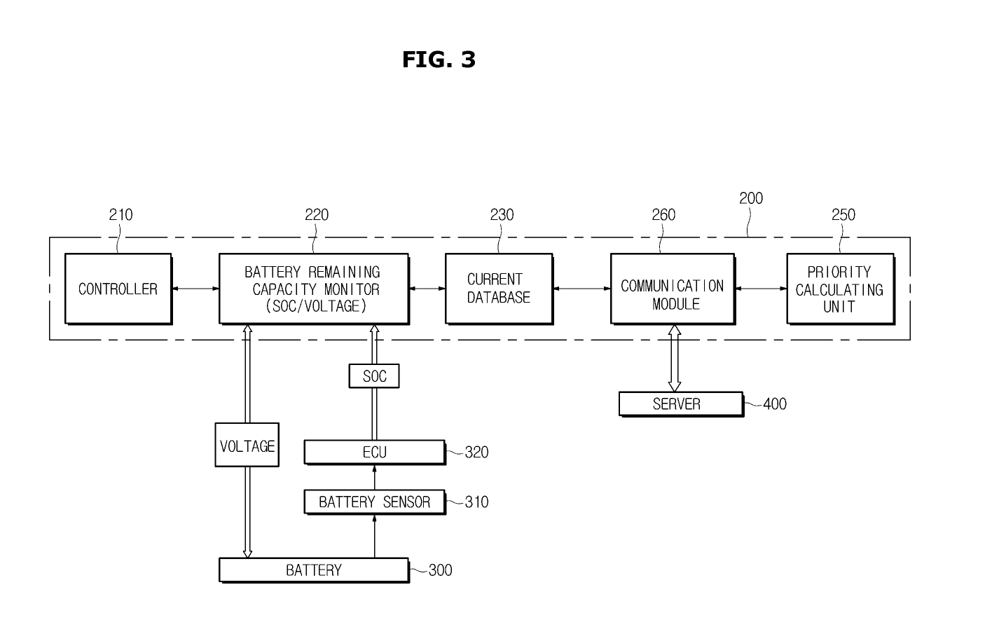

FIG. 3 is a block diagram illustrating a configuration of an apparatus for performing a software update of an electronic vehicle part according to embodiments of the present disclosure.

As shown in FIG. 3, a software update apparatus 200 of the vehicle 1 according to embodiments of the present disclosure includes a controller 210, a battery remaining capacity monitor 220, a current database 230, a priority calculator 250, and a communication module 260.

The controller 210 may include one or more processors that provide update information indication according to a scheduled update setting of the user. That is, the controller 210 receives a scheduled update time set by the user, wakes up only a head unit of the AVN 100 at the scheduled update time, and extracts and confirms information about a list of parts to be updated from an update file (e.g., binary file).

The controller 210 is a microprocessor that controls the overall operations of the software update apparatus 200 and may control the operations of various modules, devices and the like built in the software update apparatus 200. For example, the controller 210 may be operated by a processor built in the software update apparatus 200 and may generate control signals for controlling various modules, devices and the like built in the software update apparatus 200. The controller 210 is a head unit controller for performing power supply control of a head unit and updating of a peripheral unit, and is capable of controlling the entire head unit system. The controller 210 may include a memory (a storage device) that stores control data for controlling the operation of the software update apparatus 200, reference data used during operation control of the software update apparatus 200, operation data generated during execution of a predetermination operation by the software update apparatus 200, setting information, such as scheduled update setting data, input by the user for the software update apparatus 200 to perform a predetermined operation.

The battery remaining capacity monitor 220 monitors the state of charge (SOC) of a battery 300 through a battery sensor 310. As described above, the battery remaining capacity monitor 220 receives the SOC value from the battery sensor 310 and stores a relatively accurate SOC value (e.g., Kalman Filtering-based SOC) in ignition off, and wakes up at the scheduled update time by receiving a voltage from the battery 300 and calculates a SOC value having a slight error (e.g., Voltage Method-based SOC).

The battery sensor 310 is mounted on the battery 300 that supplies power to the vehicle 1, and is configured to measure the current state of the battery 300 and transmit the measured state of the battery 300 to the battery remaining capacity monitor 220. For example, the amount of remaining voltage and current of the battery 300 (i.e., the states of the battery 300) may be measured and transmitted to the battery remaining capacity monitor 220. The battery sensor 310 measures the voltage, current, and temperature of the battery 300 to determine the state of charge (SOC) of the battery 300, the state of health (SOH) of the battery 300, and the state of function (SOF) of the battery 300. Battery state information such as voltage, current, SOC, SOH, SOF, and temperature measured by the battery sensor 310 is transmitted to the battery remaining capacity monitor 220 through a vehicle battery controller 320 (ECU: Engine Control Unit).

The SOC represents the present charge capacity of the battery 300 in relation to the full charge capacity of the battery 300. The SOH also represents the present aging state of the battery 300 relative to a brand new battery. The SOF indicates how the performance of the battery 300 meets actual requirements during the use of the battery 300. The SOF may be determined by the SOC, the SOH, the operating temperature of the battery 300, and the charge/discharge history of the battery 300.

The current database 230 stores predicted current consumption values for parts that are expected when the software update of the part are updated. The predicted current consumption value for each part is obtained in advance by measurement.

The priority calculating unit 250 calculates information about parts that may be updated in the current residue state of the battery 300 by comprehensively managing the current residue information of the battery and the current consumption information for each part, and transmits the information to the controller 210.

The communication module 260 supports exchange of information with an external server 400. The communication module 260 connects the software update apparatus 200 to the server 400 via network so that the server 400 and the software update apparatus 200 may communicate with each other. For example, the communication module 260 may include a wireless fidelity (Wi-Fi) communication module that is connected to a local area network (LAN) through a wireless access point, a Bluetooth communication module that communicates in a one-to-one manner with a single external device or one-to-many with a small number of external devices, a broadcast signal receiving module that receives a digital broadcast signal, and a position information receiving module that receives position information of the vehicle 1 from a satellite.

The communication module 260 may be connected to other devices using a GSM/3GPP-based communication method (e.g., GSM, HSDPA, LTE Advanced), a 3GPP2-based communication method (e.g., CDMA, etc.), or a wireless communication protocol such as WiMAX.

The communication module 260 may transmit and receive current position information of the vehicle 1 to/from the GPS satellite or transmit and receive map information to/from the server 400 located at a remote location by transmitting and receiving data to/from the GPS satellite. The position information and the map information of the vehicle 1 may be used to provide a driving route for a user to move to a destination set by the user.

In addition, the communication module 260 may be connected to another device to transmit/receive multimedia data. Specifically, the communication module 260 may be connected to a mobile terminal located near the vehicle 1 or a server 400 located remote from the vehicle 1, to transmit multimedia data from the mobile terminal or the server 400.

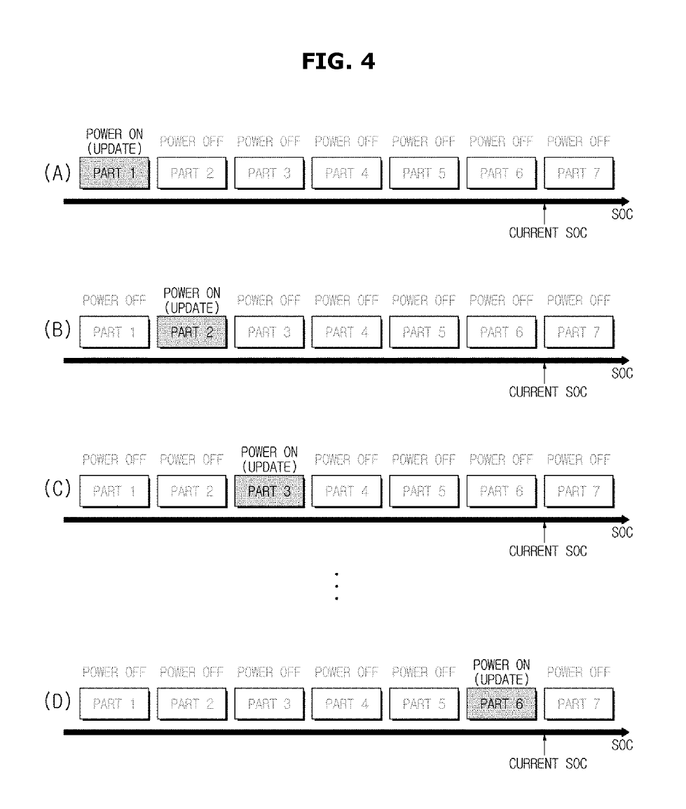

FIG. 4 is a diagram illustrating a concept of a software update of a vehicle according to embodiments of the present disclosure. According to the concept of the software update of the vehicle 1 shown in FIG. 4, among a plurality of electronic parts requiring software update, parts to perform an update are selected in consideration of the current SOC of the battery 300, software updates are performed on the selected parts one by one. As shown in FIG. 4, a software update may be performed on six electronic parts in the order of device 1 to 6 in the current SOC of the battery 300.

First, in (a) of FIG. 4, a first electronic part (part 1) is powered-on, a required software update is performed on the first part, and then the first part is powered off. Next, in (b) of FIG. 4, a second electronic part (part 2) is powered-on, a required software update is performed on the second part, and then the second part is powered off. Next, in (c) of FIG. 4, a third electronic part (part 3) is powered-on, a required software update is performed on a third part, and the third part is powered off. In this manner, for each software update target device, only one part is powered-on at a time, and then updating and powering off are performed on the one part. Finally, in (d) of FIG. 4, a sixth electronic part (part 6) is powered-on, a required software update is performed on the sixth part, and the sixth part is powered off. Therefore, instead of powering on all of the parts to be updated all at once, powering on only one part at a time, completing the update, and powering off the device can significantly reduce power consumption compared to when a plurality of parts are powered-on all at once and are subject to updates.

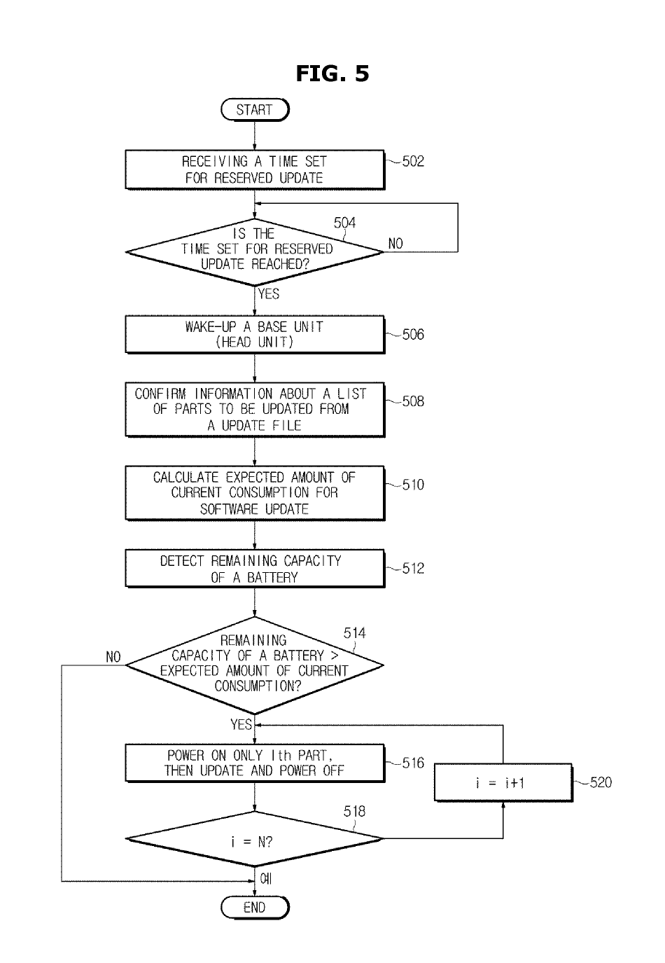

FIG. 5 is a diagram illustrating a method of a software update for a vehicle according to embodiments of the present disclosure. The software update method shown in FIG. 5 is embodied by specifying the software update concept of FIG. 4 described above.

The controller 210 receives a software update scheduled time set by a user. For example, when a user plans to not operate the vehicle 1 at a night on weekdays and sets a software update scheduled time to be a specific point in time of the night the controller 210 receives and stores the software update scheduled time set. The controller 210 determines whether the software update scheduled time set by the user is reached while counting the time (504).

When the software update scheduled time set by the user is reached (Yes in 504), the controller 210 wakes up the head unit of the AVN 100 as a base unit (506).

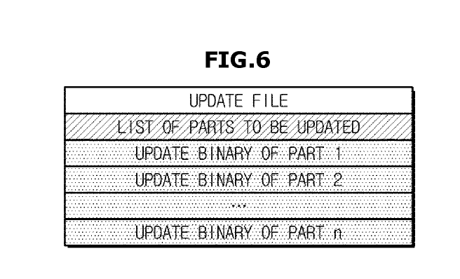

Next, the controller 210 reads the update file (e.g., binary file) from the head unit and confirms the list of parts to be updated recorded in the update file (508). FIG. 6 is a diagram illustrating a concept of the vehicle part update file according to electronic of the present disclosure.

The controller 210 calculates an expected update current consumption that is expected at the time of update of all parts to be software-updated based on expected current consumption information of each part stored in the current database 230 (510).

Also, the controller 210 determines the remaining amount of the battery 300 through the battery remaining capacity monitor 220 (512). The battery remaining capacity monitor 220 receives the SOC value of the battery 300 from the battery sensor 310 and stores a relatively accurate SOC value (e.g., SOC based on Kalman Filtering) in an ignition off state, and wakes up at the scheduled software update time by receiving a voltage from the battery 300 and calculate the SOC value (e.g., Voltage Method based SOC). The battery remaining capacity monitor 220 may calculate the SOC value based on the SOC level received from the battery controller 320 of the vehicle 1 and the voltage level directly read from the battery 300 in the previous power cycle.

The controller 210, which has obtained the battery remaining capacity and the expected amount of current consumption, compares the battery remaining capacity determined in operation 506 with the expected amount of current consumption calculated in operation 504 (514). The controller 210 performs the software update only when the actual battery remaining capacity is greater than the expected amount of current consumption.

When the actual battery remaining capacity is greater than the expected amount of current consumption, the controller 210 powers on only an i^{th} electronic part (e.g., the electronic first part) among a plurality of electronic parts to perform software update and performs software update on the i^{th} electronic part. And then the controller 210 powers off the i^{th} electronic part (516).

The controller 210 determines whether an electronic part for which software update is completed is the last part, that is, an N^{th} electronic part (518).

When the electronic part is not the last part (No in 518), the controller 210 repeats update of operation 516 on a next electronic part (i=i+1). As described in operation 516, only the i^{th} electronic part is powered-on, software of the i^{th} electronic part is updated, and then the i^{th} electronic part is powered off.

Operations 516 to 520 of FIG. 5 are performed by powering on only one electronic part at a time to complete a software update of the electronic part and powering off the electronic part as described above in FIG. 4. Therefore, power consumption is significantly reduced compared to when performing update by powering on a plurality of electronic parts all at once.

When the software update of the last electronic part (the N^{th} part) is completed (YES in 518), the controller 210 ends the software update.

The above description is merely illustrative of technical ideas, and various modifications, alterations, and permutations will be possible without departing from the essential characteristics of those skilled in the art. Therefore, the embodiments and the accompanying drawings described above are intended to illustrate and not limit the technical idea, and the scope of technical thought is not limited by these embodiments and the accompanying drawings. The scope of which is to be construed in accordance with the following claims, and all technical ideas which are within the scope of the same shall be construed as being included in the scope of protection.

What is claimed is:

1. A method for performing a software update of an electronic vehicle part, the method comprising:
calculating an expected amount of current consumption for a software update of a plurality of electronic parts equipped in a vehicle;
detecting a remaining capacity of a battery of the vehicle; and
performing the software update of the plurality of electronic parts when the remaining capacity of the battery is greater than the expected amount of current consumption,
wherein the plurality of electronic parts are powered-on one at a time to perform the software update.

2. The method of claim 1, wherein the performing of the software update comprises:
powering on one of the plurality of electronic parts;
performing the software update on the one electronic part which is powered-on; and
powering off the one electronic part when the software update is complete.

3. The method of claim 2, wherein the remaining electronic parts are powered off while the software update of the one electronic part is in progress.

4. The method of claim 1, wherein the calculating of the expected amount of current consumption comprises:
measuring and storing an amount of current required for the software update of the plurality of electronic parts before the performing of the software update; and
calculating the expected amount of current consumption based on the stored amount of current.

5. The method of claim 1, wherein the detecting of the remaining capacity of the battery comprises:
detecting the remaining capacity of the battery based on a state of charge (SOC) value and a voltage value of the battery.

6. The method of claim 1, further comprising:
detecting a time reserved for the software update; and
waking up a head unit involved in the software update of the plurality of electronic parts when the time reserved for the software update is reached.

7. An apparatus for performing a software update of an electronic vehicle part, the apparatus comprising:
a storage storing an expected amount of current consumption for a software update of a plurality of electronic parts equipped in a vehicle;
a detector detecting a remaining capacity of a battery of the vehicle; and
a controller calculating the expected amount of current consumption for the software update of the plurality of electronic parts and performing the software update of the plurality of electronic parts when the remaining capacity of the battery is greater than the expected amount of current consumption,
wherein the plurality of electronic parts are powered-on one at a time to perform the software update.

8. The apparatus of claim 7, wherein the controller powers on one of the plurality of electronic parts, performs the software update on the one electronic part which is powered-on, and powers off the one electronic part when the software update is complete.

9. The apparatus of claim 8, wherein the controller powers off the remaining electronic parts while the software update of the one electronic part is in progress.

10. The apparatus of claim 7, wherein the controller measures and stores an amount of current required for the software update of the plurality of electronic parts before the performing of the software update, and calculates the expected amount of current consumption based on the stored amount of current.

11. The apparatus of claim 7, wherein the controller detects the remaining capacity of the battery based on a state of charge (SOC) value and a voltage value of the battery.

12. The apparatus of claim 7, wherein the controller detects a time reserved for the software update, and wakes up a head unit involved in the software update of the plurality of electronic parts when the time reserved for the software update is reached.

13. A method for performing a software update of an electronic vehicle part, the method comprising:
detecting a time reserved for a software update of a plurality of electronic parts equipped in a vehicle; and
performing the software update of the plurality of electronic parts when the time reserved for the software update is reached,
wherein the plurality of electronic parts are powered-on one at a time to perform the software update.

14. The software update method of claim 13, wherein the performing of the software update comprises:
powering on one of the plurality of electronic parts;
performing the software update on the one electronic part which is powered-on; and
powering off the one electronic part when the software update is complete.

15. The method of claim 14, wherein the remaining parts are powered off while the software update of the one electronic part is in progress.

16. The method of claim 13, further comprising:
measuring and storing an amount of current required for the software update of the plurality of electronic parts before the performing of the software update; and
calculating an expected amount of current consumption based on the stored amount of current.

17. The method of claim 13, further comprising:
detecting the remaining capacity of the battery based on a state of charge (SOC) value and a voltage value of the battery.

18. A method for performing a software update of an electronic vehicle part, the method comprising:
detecting a time reserved for a software update of a plurality of electronic parts equipped in a vehicle; and
performing the software update of the plurality of a plurality of electronic parts equipped in a vehicle parts when the time reserved for the software update is reached, wherein
the plurality of electronic parts are powered-on one at a time to perform the software update, and
the performing of the software update includes:
powering on one of the plurality of electronic parts;
performing the software update on the one electronic part which is powered-on; and
powering off the one electronic part when the software update is complete.

19. An apparatus for performing a software update of an electronic vehicle part, the apparatus comprising:
a storage unit storing an expected amount of current consumption for a software update of a plurality of electronic parts equipped in a vehicle;
a detector detecting a remaining capacity of a battery of the vehicle; and
a controller calculating the expected amount of current consumption for the software update of the plurality of electronic parts and performing the software update of the plurality of electronic parts when the remaining capacity of the battery is greater than the expected amount of current consumption, wherein
the plurality of electronic parts are powered-on one at a time to perform software update, and
the software update for each part includes:
powering on one of the plurality of electronic parts;
performing the software update on the one electronic part which is powered-on; and
powering off the one electronic part when the software update is complete.
